(19) United States
(12) Patent Application Publication
(10) Pub. No.: US 2019/0313483 A1
(43) Pub. Date: Oct. 10, 2019

(54) ELECTRIC HEATER DEVICE

(71) Applicant: DENSO CORPORATION, Kariya-city (JP)

(72) Inventor: Takayuki FUKUDA, Kariya-city (JP)

(21) Appl. No.: 16/372,464

(22) Filed: Apr. 2, 2019

(30) Foreign Application Priority Data
Apr. 10, 2018 (JP) 2018-75620

(51) Int. Cl. H05B 3/40; B60H 1/03; B60H 1/22; F24H 1/10

(52) U.S. Cl. CPC H05B 3/40; F24H 1/102; B60H 1/2215; B60H 1/03

(57) ABSTRACT

An electric heater device includes: a plurality of pipes stacked with each other through a predetermined clearance as a pipe stacked body, a fluid flowing inside the plurality of pipes; a heating element disposed in the clearance between the plurality of pipes; a housing that houses the plurality of pipes and the heating element, the housing being formed separately from the pipe stacked body; and a thermal resistance structure that increases a thermal resistance between the pipe stacked body and the housing.

### CROSS REFERENCE TO RELATED APPLICATION

This application is based on Japanese Patent Application No. 2018-75620 filed on Apr. 10, 2018, the disclosure of which is incorporated herein by reference in its entirety.

### TECHNICAL FIELD

The present disclosure relates to an electric heater device.

### BACKGROUND ART

An electric heater device includes a tubular laminate in which pipes are stacked for flowing water with a predetermined gap, a heating element arranged in the gap, and a housing for housing the tubular laminate and the heating element. In the electric heater device, heat emitted from the heating element is transferred to water flowing inside of the pipe, whereby the water is heated.

### SUMMARY

According to an aspect of the present disclosure, an electric heater device includes: a plurality of pipes stacked with each other through a predetermined clearance as a pipe stacked body, a fluid flowing inside the plurality of pipes; a heating element disposed in the clearance between the plurality of pipes; a housing that houses the plurality of pipes and the heating element, the housing being formed separately from the pipe stacked body; and a thermal resistance structure that increases a thermal resistance between the pipe stacked body and the housing.

### BRIEF DESCRIPTION OF DRAWINGS

FIG. 1 is an exploded perspective view illustrating an electric heater device according to a first embodiment.

FIG. 2 is a plan view illustrating the electric heater device of the first embodiment.

FIG. 3 is a cross-sectional view illustrating an end face structure taken along a line III-III of FIG. 2.

FIG. 4 is a cross-sectional view illustrating an end face structure of an electric heater device according to a second embodiment.

FIG. 5 is a cross-sectional view illustrating an end face structure of an electric heater device according to a third embodiment.

FIG. 6 is a plan view illustrating an electric heater device according to a fourth embodiment.

FIG. 7 is a cross-sectional view illustrating an end face structure taken along a line VII-VII of FIG. 6.

### DETAILED DESCRIPTION

An electric heater device including a tubular laminate in which pipes are stacked for flowing water with a predetermined gap, a heating element arranged in the gap, and a housing for housing the tubular laminate and the heating element. In the electric heater device, heat emitted from the heating element is transferred to water flowing inside of the pipe, whereby the water is heated.

In case where the tubular laminate and the housing are in contact with each other in the electric heater device, while the water in the pipe is heated by the heating element, the heat of water may be transmitted to the outside through the housing. This is not preferable because it becomes a factor of lowering the efficiency of heating water. The present disclosure has been made in view of such circumstances, and an object thereof is to provide an electric heater device capable of improving efficiency of heating fluid.

According to an aspect of the present disclosure, an electric heater device includes: a plurality of pipes stacked with each other through a predetermined clearance as a pipe stacked body, a fluid flowing inside the plurality of pipes; a heating element disposed in the clearance between the plurality of pipes; a housing that houses the plurality of pipes and the heating element, the housing being formed separately from the pipe stacked body; and a thermal resistance structure that increases a thermal resistance between the pipe stacked body and the housing.

Accordingly, since the thermal resistance between the pipe stacked body and the housing is increased by the thermal resistance structure, the heat of fluid flowing in the pipes of the pipe stacked body is not easily transmitted to the housing. The temperature of the fluid heated by the heating element can be kept high, so that the efficiency of heating the fluid can be improved.

Hereinafter, embodiments will be described with reference to the drawings. For easy understanding, the same reference numerals are attached to the same elements among the drawings where possible, and redundant explanations are omitted.

### First Embodiment

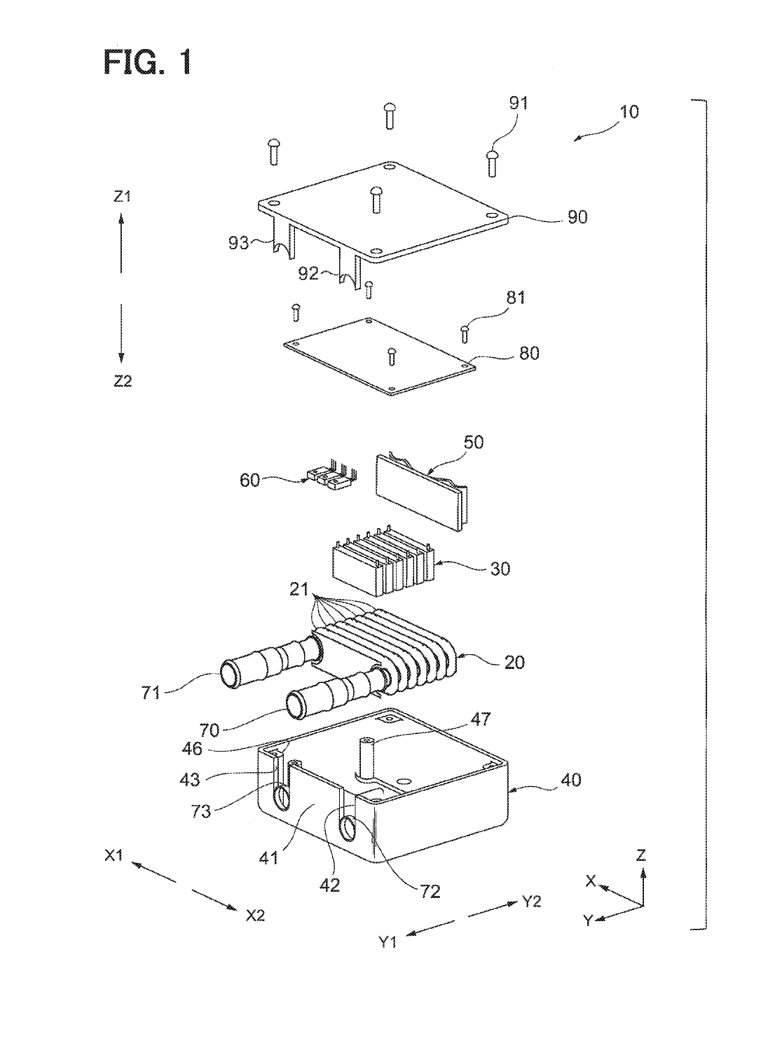

An electric heater device 10 of a first embodiment will be described with reference to FIG. 1. The electric heater device 10 is used, for example, to raise the temperature of a heater core by electrically heating water circulating through the heater core in an air conditioner for a vehicle. It is possible to raise the temperature of air blown into the passenger compartment by raising the temperature of the heater core, so that the heating of the passenger compartment becomes possible. In the electric heater device 10 of the present embodiment, water is used as a fluid to be heated.

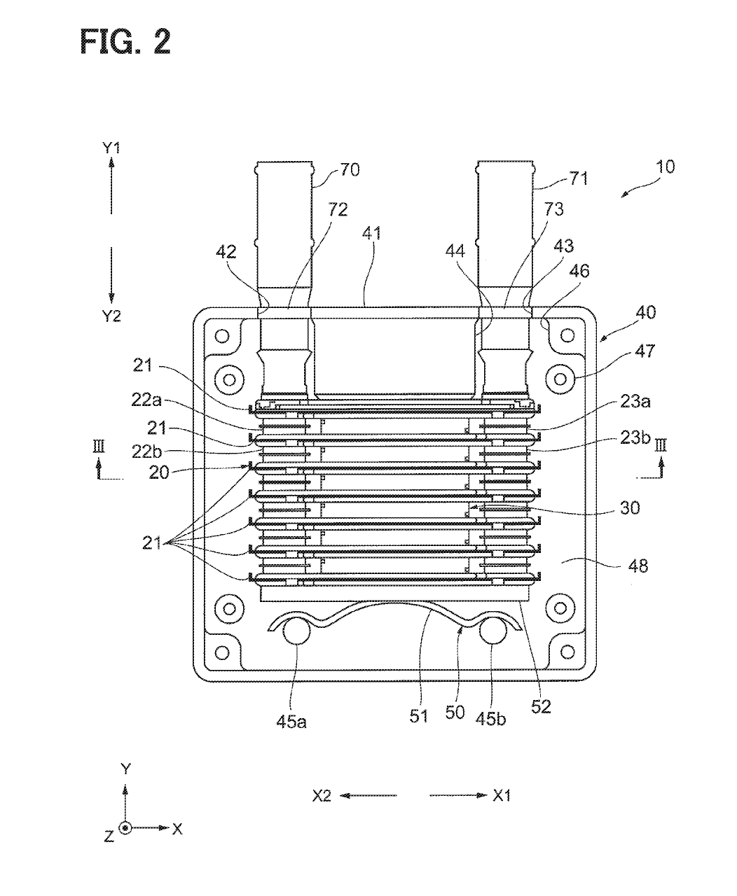

As shown in FIG. 1, the electric heater device 10 includes a pipe stacked body 20, plural heating elements 30, a housing 40, a pressing member 50, a switching element 60, a substrate 80, and an upper lid 90. As shown in FIG. 2, the pipe stacked body 20 includes plural flat pipes 21, through which water flows, stacked with each other through a predetermined clearance in the Y-axis direction. Hereinafter, one direction in the Y-axis direction is referred to as “Y1 direction”, and the opposite direction is referred to as “Y2 direction”. Further, the longitudinal direction of the pipe 21 is referred to as “X-axis direction”. One direction in the X-axis direction is referred to as “X1 direction”, and the opposite direction is referred to as “X2 direction”. Further, as shown in FIG. 1, a direction perpendicular to both the X-axis direction and the Y-axis direction is referred to as Z-axis direction. One direction in the Z-axis direction is referred to as “Z1 direction”, and the opposite direction is referred to as “Z2 direction”.

An end portion of each pipe 21 in the X2 direction has a tubular connecting portion 22a projecting in the Y1 direction and a tubular connecting portion 22b projecting in the Y2 direction. The ends of the pipes 21 in the X2 direction are communicated with each other by connecting the connecting portions 22a and 22b of the pipes 21 adjacent to each other. An end portion of each pipe 21 in the X1 direction has a tubular connecting portion 23a projecting in the Y1 direction and a tubular connecting portion 23b projecting in the Y2 direction. The ends of the pipes 21 in the X1 direction are communicated with each other by connecting the connecting portions 23a and 23b of the pipes 21 adjacent to each other.

An inflow pipe 70 is connected to the pipe 21 at the endmost part of the pipe stacked body 20 in the Y1 direction, instead of the connecting portion 22a. An outflow pipe 71 is connected to the pipe 21 at the endmost part of the pipe stacked body 20 in the Y1 direction, instead of the connecting portion 23a. The pipe 21 at the endmost part of the pipe stacked body 20 in the Y2 direction does not have the connecting portions 22b, 23b, and the corresponding parts are closed.

In the pipe stacked body 20, water flowing into the inflow pipe 70 is distributed through the connecting portions 22a, 22b into each of the pipes 21, and water flows in each of the pipes 21 in the X1 direction. The water flowing through each of the pipes 21 is collected by the connecting portions 23a, 23b and then flows out of the outflow pipe 71.

The heating element 30 is disposed in a clearance between the pipes 21 adjacent to each other. The heating element 30 emits heat when being supplied with electric power. The water flowing inside each of the pipes 21 is heated by heat exchange between the heating element 30 and the pipe 21. As shown in FIG. 1, the housing 40 has a rectangular box shape with an opening in the Z1 direction. The pipe stacked body 20 and the heating element 30 are housed inside the housing 40. The housing 40 is formed separately from the pipe stacked body 20 and the heating element 30, and is made of a metal material having high thermal conductivity such as aluminum.

A side wall 41 of the housing 40 in the Y1 direction has U-shaped insertion grooves 42, 43 extending from the upper end surface in the Z2 direction. The inflow pipe 70 is inserted into the insertion groove 42. The outflow pipe 71 is inserted into the insertion groove 43. The inflow pipe 70 and the outflow pipe 71 extend from the inside of the housing 40 to the outside through the respective insertion grooves 42, 43.

An annular spacer 72 is disposed in the insertion groove 42 to fill a gap between the inner peripheral surface of the insertion groove 42 and the inflow pipe 70. Similarly, an annular spacer 73 is disposed in the insertion groove 43 to fill a gap between the inner peripheral surface of the insertion groove 43 and the outflow pipe 71. As shown in FIG. 2, the housing 40 has a contact portion 44 in contact with the endmost pipe 21 in the Y1 direction, of the pipe stacked body 20. The contact portion 44 is formed of a thick portion protruding into the housing 40 from the side wall 41 of the housing 40 in an area between the insertion groove 42 and the insertion groove 43. The pipe stacked body 20 is pressed against the contact portion 44 by the pressing member 50.

Specifically, the pressing member 50 includes a spring member 51 and a plate member 52. The plate member 52 is in surface contact with the pipe 21 located at the endmost portion of the pipe stacked body 20 in the Y2 direction. The spring member 51 is made of a leaf spring curved in an arc shape. The central portion of the spring member 51 is in contact with the plate member 52. Respective end portions of the spring member 51 are supported by columnar fixing pins 45a and 45b fixed to the housing 40. The spring member 51 in a compressed state is inserted between the fixing pin 45a, 45b and the plate member 52. Therefore, the pipe stacked body 20 is pressed against the contact portion 44 by the elastic force applied from the spring member 51 via the plate member 52. As a result, the pipes 21 and the heating elements 30 are made in close contact, so that it is possible to enhance the thermal conductivity therebetween.

A female threaded portion 46 is provided at four corners of the housing 40, and has a female threaded hole. As shown in FIG. 1, a bolt 91 is screwed into the female threaded portion 46 to fix the upper lid 90 to the housing 40. When the upper lid 90 is assembled to the housing 40, the opening of the housing 40 is closed. The upper lid 90 has protrusions 92, 93 to be inserted into the insertion grooves 42, 43, respectively. The protrusion 92, 93 presses the spacer 72, 73 from the upper side.

As shown in FIG. 2, plural columnar female threaded portions 47 are formed inside the housing 40, each of which has a female threaded hole. As shown in FIG. 1, a bolt 81 is screwed into the female threaded portion 47 to fix the substrate 80 to the housing 40. The heating elements 30 and the switching elements 60 are mounted on the substrate 80. The switching element 60 is formed of an IGBT, a MOSFET, or the like, and switches on/off to supply/stop electric power to the heating element 30. Further, sensors for detecting various states (quantities) of the electric heater device 10, a control device for controlling the switching element 60, and the like are mounted on the substrate 80. The sensors may include, for example, a temperature sensor for detecting the temperature of water flowing through the pipe 21 of the pipe stacked body 20. The control device controls the energization amount of the heating element 30 by switching on/off the switching element 60 based on the temperature of the water detected by the temperature sensor. The control device controls the amount of heat generated by the heating element 30 by controlling the electric power supplied to the heating element 30 to adjust the temperature of the water.

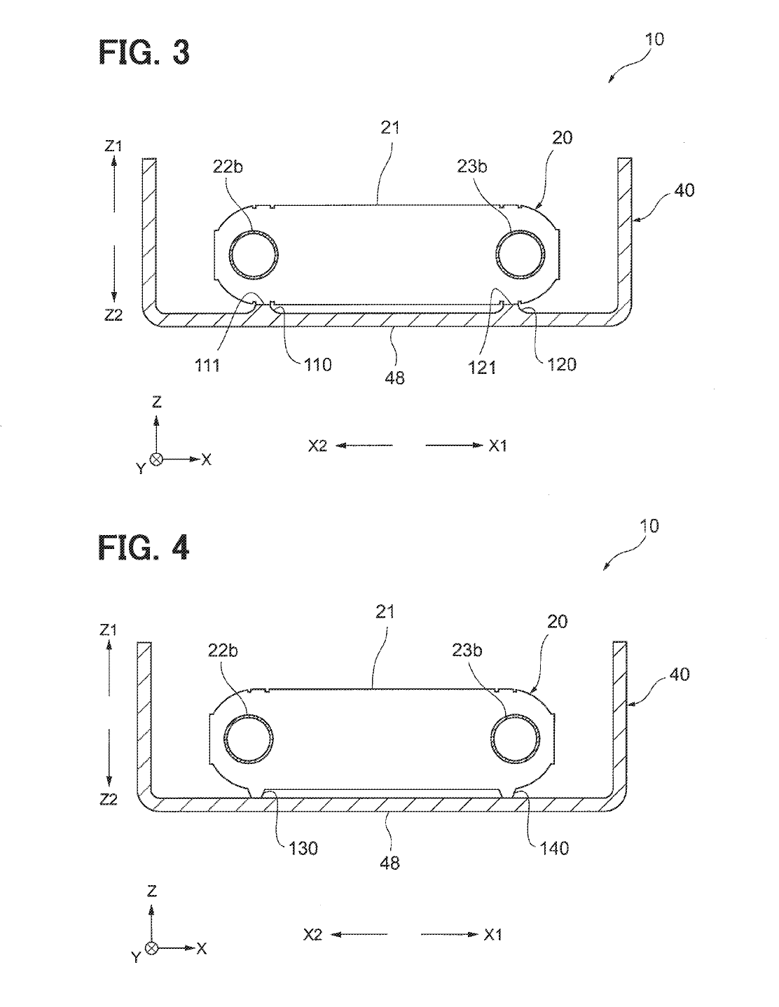

As shown in FIG. 3, the housing 40 has a bottom plate portion 48 opposed to the pipe stacked body 20 in the Z-axis direction. A rib 110 and a rib 120 are formed on the bottom plate portion 48 to protrude in the Z1 direction from the housing 40 toward the pipe stacked body 20. A flat surface 111 is formed at the tip end of the rib 110 in the Z1 direction, and a flat surface 121 is formed at the tip end of the rib 120 in the Z1 direction. The bottom surface of the end portion of the pipe 21 in the X2 direction is in contact with the flat surface 111. The bottom surface of the end portion of the pipe 21 in the X1 direction is in contact with the flat surface 121. A space is formed between the bottom plate portion 48 of the housing 40 and the pipe stacked body 20 by the ribs 110, 120.

According to the electric heater device 10, since a space can be formed between the bottom plate portion 48 of the housing 40 and the pipe stacked body 20 by the ribs 110, 120, it is possible to reduce the contact area between the bottom plate portion 48 of the housing 40 and the pipe stacked body 20, compared with a case where the ribs 110, 120 are not provided. Therefore, the thermal resistance between the housing 40 and the pipe stacked body 20 can be increased. That is, in the electric heater device 10 of the present embodiment, the ribs 110, 120 correspond to a thermal resistance structure. Since the thermal resistance between the pipe stacked body 20 and the housing 40 is increased by the ribs 110 and 120, heat of water flowing in the pipe 21 of the pipe stacked body 20 is hardly transmitted to the housing 40. Therefore, the temperature of the water heated by the heating element 30 can be kept high. Thus, the efficiency of heating water can be improved.

### Second Embodiment

A second embodiment of the electric heater device 10 will be described. Hereinafter, differences from the electric heater device 10 of the first embodiment will be mainly described.

In the electric heater device 10 of the first embodiment, the ribs 110, 120 are formed on the housing 40. In contrast, in the electric heater device 10 of the present embodiment, as shown in FIG. 4, ribs 130 and 140 are formed on the pipe stacked body 20. Specifically, the rib 130 is formed to protrude from the bottom surface of the end portion of the pipe 21 in the X2 direction toward the bottom plate portion 48 of the housing 40. The rib 140 is formed to protrude from the bottom surface of the end portion of the pipe 21 in the X1 direction toward the bottom plate portion 48 of the housing 40. A space is formed between the bottom plate portion 48 of the housing 40 and the tube stacked body 20 by the ribs 130, 140.

According to the electric heater device 10 of the second embodiment, it is possible to increase the thermal resistance between the housing 40 and the pipe stacked body 20, similarly to the electric heater device 10 of the first embodiment. That is, in the electric heater device 10 of the present embodiment, the ribs 130 and 140 correspond to a thermal resistance structure. Since the thermal resistance between the pipe stacked body 20 and the housing 40 is increased by the ribs 130 and 140, heat of water flowing in the pipe 21 of the pipe stacked body 20 is hardly transmitted to the housing 40. Therefore, the temperature of the water heated by the heating element 30 can be kept high. Thus, the efficiency of heating water can be improved.

### Third Embodiment

A third embodiment of the electric heater device 10 will be described. Hereinafter, differences from the electric heater device 10 of the first embodiment will be mainly described.

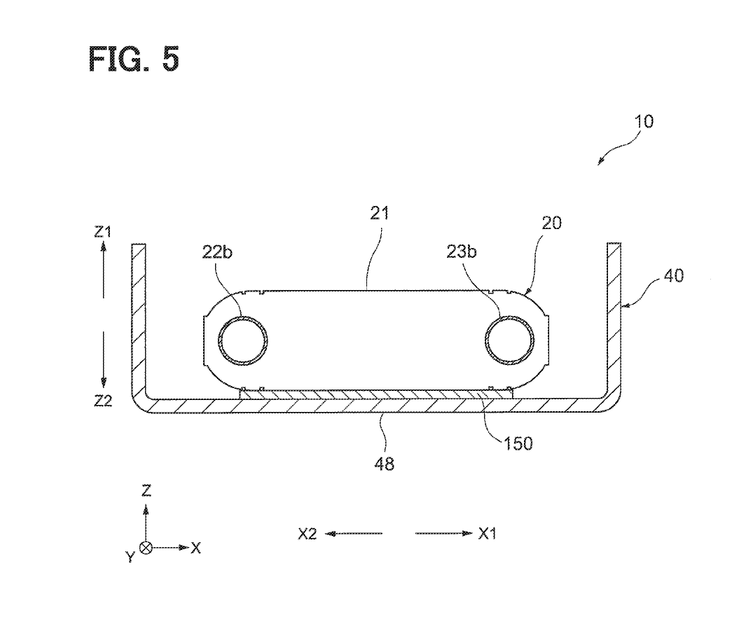

In the electric heater device 10 of the first embodiment, the ribs 110, 120 are formed on the housing 40. In contrast, in the electric heater device 10 of the present embodiment, as shown in FIG. 5, a thermal conduction inhibiting member 150 is provided to inhibit thermal conduction between the pipe stacked body 20 and the housing 40. The thermal conduction inhibiting member 150 is formed of, for example, a heat insulating material.

According to the electric heater device 10 of the third embodiment, it is possible to increase the thermal resistance between the housing 40 and the pipe stacked body 20 by the thermal conduction inhibiting member 150. That is, in the electric heater device 10 of the present embodiment, the thermal conduction inhibiting member 150 corresponds to a thermal resistance structure. Heat of water flowing in the pipe 21 of the pipe stacked body 20 is less likely to be transmitted to the housing 40, by increasing the thermal resistance between the pipe stacked body 20 and the housing 40 using the thermal conduction inhibiting member 150. Therefore, the temperature of the water heated by the heating element 30 can be kept high. Thus, the efficiency of heating water can be improved.

### Fourth Embodiment

A fourth embodiment of the electric heater device 10 will be described. Hereinafter, differences from the electric heater device 10 of the first embodiment will be mainly described.

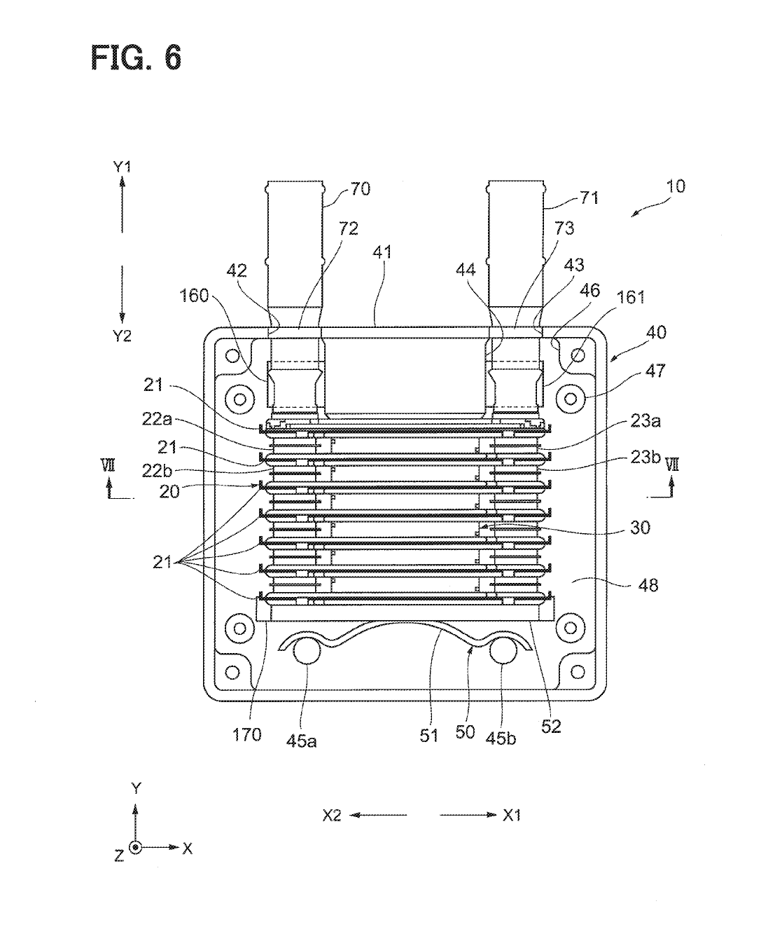

As shown in FIG. 6, the electric heater device 10 of the present embodiment includes holding members 160, 161, 170 for respectively holding the inflow pipe 70, the outflow pipe 71, and the plate member 52, such that a space is formed between the bottom plate portion 48 of the housing 40 and the pipe stacked body 20, instead of the ribs 110, 120 of the first embodiment.

Specifically, the holding member 160 is provided between the bottom plate portion 48 of the housing 40 and the inflow pipe 70, and holds the inflow pipe 70 to be separated from the bottom plate portion 48 of the housing 40. The holding member 161 is provided between the bottom plate portion 48 of the housing 40 and the outflow pipe 71, and holds the outflow pipe 71 to be separated from the bottom plate portion 48 of the housing 40. The holding member 170 is provided between the bottom plate portion 48 of the housing 40 and the plate member 52, and holds the plate member 52 to be separated from the bottom plate portion 48 of the housing 40.

As described above, the pipe stacked body 20 is supported between the contact portion 44 of the housing 40 and the plate member 52 by the elastic force of the spring member 51. Therefore, the positional displacement of the pipe stacked body 20 is not generated with respect to the housing 40 and the plate member 52 due to the frictional force between the pipe 21 of the pipe stacked body 20 and the contact portion 44 of the housing 40 and the frictional force between the pipe 21 of the pipe stacked body 20 and the plate member 52.

Therefore, the pipe stacked body 20 can be supported in a state of being separated from the bottom plate portion 48 of the housing 40, since the holding members 160, 161, and 170 respectively hold the inflow pipe 70, the outflow pipe 71, and the plate member 52 to be separated from the bottom plate portion 48 of the housing 40. That is, in the present embodiment, the holding members 160, 161, and 170 correspond to a holding member that holds the pipe stacked body 20 to be separated from the bottom plate portion 48 of the housing 40.

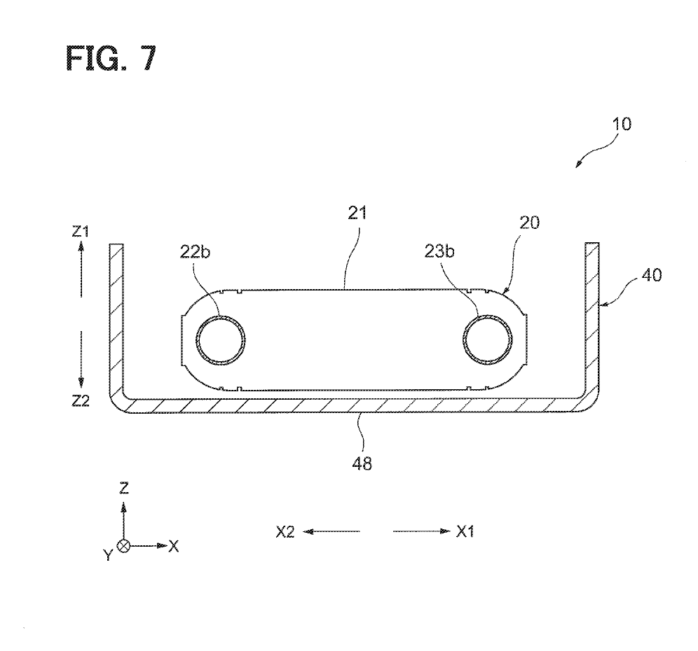

In this way, as shown in FIG. 7, a space can be formed between the bottom plate portion 48 of the housing 40 and the pipe stacked body 20 by holding the pipe stacked body 20 to be separated from the bottom plate portion 48 of the housing 40. Therefore, the thermal resistance between the housing 40 and the pipe stacked body 20 can be increased. That is, in the electric heater device 10 of the present embodiment, the holding members 160, 161, and 170 correspond to a thermal resistance structure. Therefore, the heat of water flowing in the pipe 21 of the pipe stacked body 20 is less likely to be transmitted to the housing 40, so that the temperature of the water heated by the heating element 30 can be kept high. Therefore, the efficiency of heating water can be improved.

### Other Embodiments

The electric heater device 10 may heat appropriate fluid other than water.

The present disclosure is not limited to the specific examples described above. The specific examples described above which have been appropriately modified in design by those skilled in the art are also encompassed in the scope of the present disclosure so far as the modified specific examples have the features of the present disclosure. Each element included in each of the specific examples described above, and the placement, condition, shape, and the like of the element are not limited to those illustrated, and can be modified as appropriate. The combinations of elements included in each of the above described specific examples can be appropriately modified as long as no technical inconsistency occurs.

What is claimed is:

1. An electric heater device comprising:
a plurality of pipes stacked with each other through a predetermined clearance as a pipe stacked body, a fluid flowing inside the plurality of pipes;
a heating element disposed in the clearance between the plurality of pipes;
a housing that houses the plurality of pipes and the heating element, the housing being formed separately from the pipe stacked body; and
a thermal resistance structure that increases a thermal resistance between the pipe stacked body and the housing.

2. The electric heater device according to claim 1, wherein
the thermal resistance structure includes a rib of the housing protruding toward the pipe stacked body.

3. The electric heater device according to claim 1, wherein
the thermal resistance structure includes a rib of the pipe stacked body protruding toward the housing.

4. The electric heater device according to claim 1, wherein
the thermal resistance structure includes a thermal conduction inhibiting member disposed between the pipe stacked body and the housing to inhibit thermal conduction between the pipe stacked body and the housing.

5. The electric heater device according to claim 1, wherein
the thermal resistance structure includes a holding member that holds the pipe stacked body to be separated from the housing.
